(19) United States
(12) Patent Application Publication
(10) Pub. No.: US 2026/0188676 A1
(43) Pub. Date: Jul. 2, 2026

(54) Secondary Battery

(71) Applicant: Nippon Telegraph and Telephone Corporation, Tokyo (JP)

(72) Inventors: Sho Okubo, Musashino-shi, Tokyo (JP); Takeshi Komatsu, Musashino-shi, Tokyo (JP); Hiroaki Taguchi, Musashino-shi, Tokyo (JP); Masaya Nohara, Musashino-shi, Tokyo (JP); Shuhei Sakamoto, Musashino-shi, Tokyo (JP)

(21) Appl. No.: 18/863,291

(22) PCT Filed: May 13, 2022
(86) PCT No.: PCT/JP2022/020214

§ 371 Date: Nov. 5, 2024

(51) Int. Cl. H01M 4/60; H01M 4/66; H01M 4/80; H01M 10/054; H01M 50/109

(52) U.S. Cl. CPC H01M 4/604; H01M 4/663; H01M 4/806; H01M 10/054; H01M 50/109

(57) ABSTRACT

A secondary battery includes: a positive electrode containing cystine; a negative electrode containing magnesium, sodium, or calcium; and an electrolyte disposed between the positive electrode and the negative electrode.

### TECHNICAL FIELD

The present invention relates to a secondary battery.

### BACKGROUND ART

Conventionally, a secondary battery such as a lead storage battery, a lithium ion secondary battery, a lithium ion polymer secondary battery, a nickel-hydrogen storage battery, or a nickel-cadmium storage battery is widely used for a small device, a sensor, or a mobile device or the like. As the Internet of Things (IoT) has been developed recently, scattered type sensors that are to be placed and used at various places in nature, such as in the soil and in forests, have been developed.

An air battery having a low environmental load has also been studied (Patent Literature 1).

### CITATION LIST

### Patent Literature

Patent Literature 1: JP 6711915 B

### SUMMARY OF INVENTION

### Technical Problem

In a conventional battery, a material having a high environmental load such as a lead compound, a cadmium compound, a manganese compound, a nickel compound, or a fluorine compound is used, and a specific treatment is required at the time of disposal. Therefore, the conventional battery is not suitable for disposal as general waste or mounting on a scattered type sensor. Therefore, a battery composed only of a material having a low environmental load is required.

The basis of the battery of Patent Literature 1 is the basis of an air battery, and the battery uses oxygen in the air as a positive electrode active material, and therefore an air intake port is essential for the battery. Therefore, the air battery has a disadvantage that it is not suitable for long-term use since an electrolytic solution volatilizes from the air intake port. Therefore, a new low environmental load battery that does not require oxygen for the positive electrode active material is required.

The secondary battery can be charged and discharged, and can be repeatedly used. Therefore, the waste amount of the secondary battery can be reduced as compared with a primary battery having the same capacity and voltage, and the secondary battery has a low environmental load.

The present invention has been made in view of the above circumstances, and an object of the present invention is to provide a secondary battery having a low environmental load and capable of being used for a long period of time.

### Solution to Problem

A secondary battery according to an aspect of the present invention includes: a positive electrode containing cystine; a negative electrode containing magnesium, sodium, or calcium; and an electrolyte disposed between the positive electrode and the negative electrode.

### Advantageous Effects of Invention

The present invention can provide a secondary battery having a low environmental load and capable of being stored for a long period of time.

### BRIEF DESCRIPTION OF DRAWINGS

FIG. 1 is a schematic view of a secondary battery of the present embodiment.

FIG. 2 is a schematic cross-sectional view showing the structure of a coin-type secondary battery.

### DESCRIPTION OF EMBODIMENTS

Hereinafter, an embodiment of the present invention will be described with reference to the drawings.

### [Configuration of Secondary Battery]

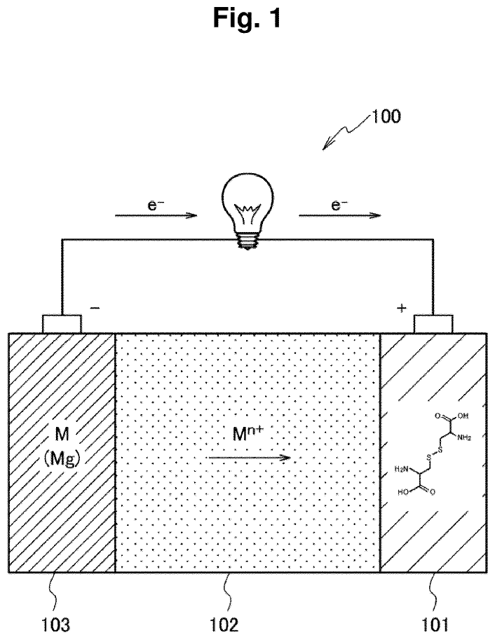

FIG. 1 is a configuration diagram showing the configuration of a secondary battery 100 according to an embodiment of the present invention. The secondary battery 100 includes a positive electrode 101 containing cystine, a negative electrode 103 containing magnesium, sodium, or calcium, and an electrolyte 102 disposed between the positive electrode 101 and the negative electrode 103. As the electrolyte 102, a non-aqueous electrolytic solution is preferably used. In the present embodiment to be described below, a case where magnesium is used for the negative electrode 103 and a non-aqueous electrolytic solution is used for the electrolyte 102 will be described as an example, but the present invention is not limited thereto.

A charge-discharge reaction in the negative electrode 103 is represented by Formula (1). A charge-discharge reaction in the positive electrode 101 is represented by Formula (2).

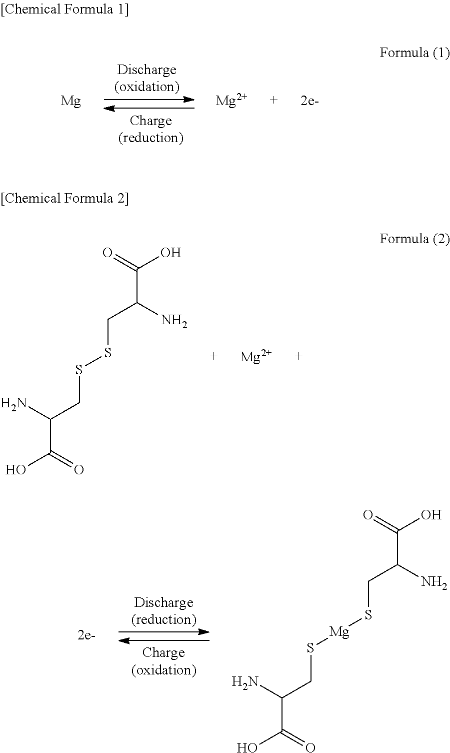

A disulfide bond of cystine contained in the positive electrode 101 is cleaved by electrochemical reduction during discharge, and regenerated by electrochemical oxidation during charge.

During discharge, as represented by Formula (1), electrochemical oxidation occurs in the negative electrode 103. Magnesium emits magnesium ions (Mg⁺) and electrons. Meanwhile, electrochemical reduction occurs in the positive electrode 101. The disulfide bond of cystine is cleaved and reacts with the magnesium ions and the electrons released in the negative electrode 103 to produce a magnesium salt.

During charge, the reaction proceeds in the reverse direction. Specifically, electrochemical oxidation occurs in the positive electrode 101, and the magnesium salt returns to cystine. Electrochemical reduction occurs in the negative electrode 103, and the magnesium ions return to magnesium.

Cystine contained in the positive electrode 101 may be in a polymerized state. Examples of the polymerized cystine include a polymer represented by Formula (3).

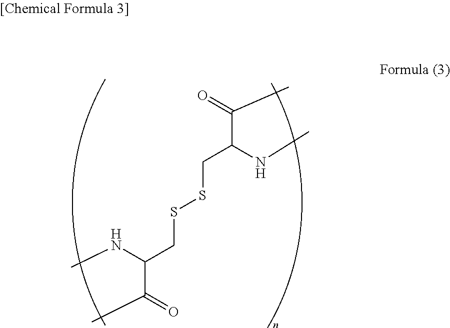

The positive electrode 101 contains a polymer containing a repeating unit represented by Formula (4) as the polymerized cystine represented by Formula (3).

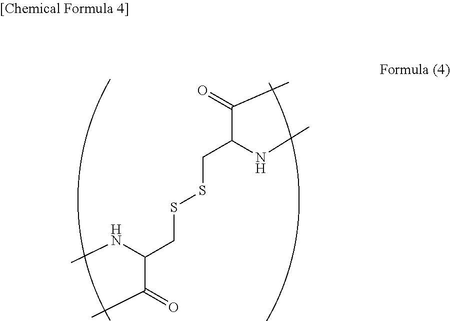

When a polymer compound is used as an active material contained in the positive electrode 101, the active material is hardly dissolved in the electrolyte 102 by an electrochemical reaction. The positive electrode 101 can be expected to have excellent stability with little deterioration over a long period of time. The molecular weight of the polymer compound of cystine is preferably 10,000 or more, and more preferably 100,000 or more.

A theoretical electromotive force is about 2.5 V when cystine is used for a positive electrode active material and Mg is used for a negative electrode active material. The theoretical electromotive force is about 3.0 V when cystine is used for the positive electrode active material and Na or Ca is used for the negative electrode active material.

The secondary battery 100 of the present embodiment can be expected as a battery having a low environmental load by using cystine as a positive electrode active material, magnesium, sodium, or calcium as a negative electrode active material, and a non-aqueous electrolytic solution having no fluorine compound as an electrolyte. The positive electrode 101 can contain the positive electrode active material and a conductive auxiliary agent as constituent elements, and the negative electrode 103 can contain the negative electrode active material and a conductive auxiliary agent as constituent elements.

Each of the above constituent elements will be described below.

### (1) Positive Electrode

The positive electrode 101 contains at least cystine which is the positive electrode active material, and may contain a current collector as necessary. The positive electrode 101 is preferably formed into a porous body containing at least one selected from the group consisting of aluminum, copper, and iron, or a nonwoven fabric-shaped current collector containing carbon. Alternatively, the positive electrode 101 may be formed into a co-continuous body having a three-dimensional network structure provided by branching of a plurality of integrated nanostructures.

In the present embodiment, the positive electrode 101 is preferably formed without containing a binder. In a conventional positive electrode production method, a binder is used for stabilizing the structure of the positive electrode (securing the stability of discharge), but there is a disadvantage that the binder causes an increase in internal resistance. Meanwhile, in the positive electrode 101 of the embodiment, cystine is directly supported on a network structure such as a nonwoven fabric-shaped current collector or a co-continuous body, and therefore the structure of the positive electrode can be stabilized without using the binder, and a decrease in the internal resistance of the battery can be expected as compared with a conventional production method using a binder.

As described above, the positive electrode 101 containing cystine which is a positive electrode active material can achieve high activity for a charge reaction and a discharge reaction. Furthermore, the positive electrode 101 of the secondary battery having the above-described configuration can sufficiently draw the potential of cystine which is a positive electrode active material.

### (1-1) Positive Electrode Active Material

The positive electrode active material of the present embodiment contains at least cystine. Cystine is biologically derived, and therefore it has a low environmental load and is inexpensive.

The positive electrode active material is preferably in a polymer state. This is because when the molecular weight of the positive electrode active material is small, the positive electrode active material is easily dissolved in the electrolytic solution. The molecular weight of the positive electrode active material is preferably 10,000 or more, and more preferably 100,000 or more.

Cystine can be obtained, for example, as a commercially available product or by known synthesis, and a polymer compound of cystine can be obtained by known synthesis.

### (1-2) Preparation of Positive Electrode Using Conductive Auxiliary Agent

In another embodiment, the positive electrode 101 containing cystine may contain a conductive auxiliary agent and a binder. As the conductive auxiliary agent, for example, carbon can be used. Specific examples of the conductive auxiliary agent include carbon blacks such as Ketjen black and acetylene black, activated carbons, graphites, and carbon fibers. In order to sufficiently ensure a reaction site in the positive electrode 101, carbon having a small particle size is suitable. Specifically, carbon having a particle size of 1 μm or less is desirable. Such carbon can be obtained, for example, as a commercially available product or by known synthesis. Specific examples of the binder include polytetrafluoroethylene (PTFE), polyvinylidene fluoride (PVDF), styrene butadiene rubber, ethylene propylene diene rubber, and natural rubber.

As described above, in another Example, in addition to a cystine powder which is a positive electrode active material, the positive electrode 101 may be prepared by mixing a conductive auxiliary agent and a binder and bonding the mixture to a conductive material in the same manner as in a conventional positive electrode production method.

### (1-3) Preparation of Positive Electrode Using Current Collector

In the present embodiment, a porous body containing at least one selected from the group consisting of aluminum, copper, and iron, or a nonwoven fabric-shaped current collector containing carbon may directly support the positive electrode active material. The porous body or the nonwoven fabric-shaped current collector can be obtained, for example, as a commercially available product.

The co-continuous body having a three-dimensional network structure in which a plurality of nanostructures are integrated by non-covalent bonds may directly support the positive electrode active material without using a binder. Here, in the co-continuous body, a bonding portion between the nanostructures is deformable, and therefore the co-continuous body has an integral structure having stretchability. The co-continuous body preferably has, for example, an average pore diameter of 0.1 to 50 μm. The nanostructure is a nanosheet or a nanofiber, and has conductivity. The nanosheet is, for example, graphene. Examples of the nanofiber include iron oxide, manganese oxide, silicon, and carbonized cellulose. The nanofiber is a fibrous substance that has a diameter of 1 nm to 1 μm, and a length 100 or more times greater than the diameter. Here, the carbonized cellulose can be manufactured by heating and carbonizing a gel in which nanofibers made of cellulose are dispersed in an inert gas atmosphere.

The co-continuous body can be manufactured by drying, in vacuum, a frozen product obtained by freezing a sol or gel in which nanostructures such as nanosheets or nanofibers are dispersed. Specifically, the dispersion medium of the sol is an aqueous system such as water, or an organic system such as carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, or glycerin. As the dispersion medium of the sol, two or more kinds selected from these organic systems may be mixed. Specifically, the dispersion medium of the gel is an aqueous system such as water (H₂O) or an organic system such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, or glycerin. As the dispersion medium of the gel, two or more kinds selected from these aqueous or organic systems may be mixed.

The degree of vacuum in the drying step varies with the dispersion medium being used, but is not limited to any specific degree as long as the dispersion medium sublimates. For example, in a case where water is used as the dispersion medium, the degree of vacuum needs to be set so that the pressure becomes 0.06 MPa or lower. However, heat is taken away as latent heat of sublimation, and therefore, drying takes time. Therefore, the degree of vacuum is preferably 1.0×10⁻⁶ to 1.0×10⁻² Pa. Furthermore, heat may be applied using a heater or the like during drying. The co-continuous body can have a larger specific surface area than that of a commercially available conductive porous body or nonwoven fabric-shaped current collector. The specific surface area of the co-continuous body is preferably 200 m²/g or more.

Examples for a method for supporting the positive electrode active material on the porous body or the nonwoven fabric-shaped current collector, or the co-continuous body include a physical method such as vapor deposition, sputtering, or a planetary ball mill, a chemical method such as a method for immersing the porous body or the nonwoven fabric-shaped current collector, or the co-continuous body in a liquid in which the positive electrode active material is dissolved, followed by drying, or a sol-gel method, or a known method. In order to form the positive electrode 101 which is simple and excellent in quality, in a preferable method, the porous body or the nonwoven fabric-shaped current collector, or the co-continuous body is immersed in the liquid in which the positive electrode active material is dissolved, and the co-continuous body immersed in the liquid in which the positive electrode active material is dissolved is then dried to support the positive electrode active material. Herein, cold pressing or hot pressing is applied to the dried electrode to increase the strength of the electrode, and therefore the positive electrode 101 having more excellent stability can be produced, Specifically, a solvent for dissolving the positive electrode active material is an aqueous system such as water, or an organic system such as tetrahydrofuran (THF), tetrahydroplan (THP), dioxane, diethyl ether, N-methyl-2-pyrrolidone (NMP), hexamethylphosphoric acid amide (HMPA), tetramethylurea (TMU), dimethylacetamide (DMAc), dimethylformaldehyde (DMF), dimethylsulfoxide (DMSO), m-cresol, or chloroform. As the solvent, two or more kinds selected from these aqueous or organic solvents may be mixed.

In the secondary battery 100 of the present embodiment, the reaction represented by Formula (2) proceeds on the surface of the positive electrode 101, and therefore it is preferable to generate a large amount of reaction sites inside the positive electrode 101. In the case of a conventional positive electrode molded using the above-described conductive auxiliary agent and binder, binding strength between the conductive auxiliary agents decreases when the specific surface area is increased, and the structure deteriorates, so that it is difficult to stably discharge an electrical current, and the discharge capacity decreases. Meanwhile, the positive electrode 101 molded using the porous body or the nonwoven fabric-shaped current collector, or the co-continuous body can secure a large amount of reaction sites and solve the above-described conventional problems, so that the discharge capacity can be increased. In particular, the co-continuous body has a high bulk density and can support a larger amount of the positive electrode active material, so that the efficiency of the battery can be increased.

As described above, by producing the positive electrode containing cystine which is a positive electrode active material, the positive electrode 101 highly active to a charge reaction and a discharge reaction can be obtained. Furthermore, by producing the positive electrode 101 of the secondary battery 100 having the above-described configuration, it is possible to sufficiently draw the potential of cystine which is a positive electrode active material.

### (2) Negative Electrode

The secondary battery 100 of the present embodiment contains at least magnesium (Mg), sodium (Na), or calcium (Ca) as a negative electrode active material. The negative electrode active material may contain magnesium (Mg), sodium (Na), or calcium (Ca) as a main component. The negative electrode active material may be an alloy containing at least one component selected from the group consisting of lithium (Li), zinc (Zn), aluminum (Al), iron (Fe), tin (Sn), and carbon (C) in addition to magnesium (Mg), sodium (Na), or calcium (Ca).

### (3) Electrolyte

The secondary battery 100 of the present embodiment contains a non-aqueous electrolytic solution as the electrolyte 102. The non-aqueous electrolytic solution is a solution containing an electrolyte in which magnesium ions (Mg²⁺), sodium ions (Na⁺), or calcium ions (Ca²⁺) can move. The non-aqueous electrolytic solution contains an organic solvent as a main solvent, and may contain, for example, water in addition to the organic solvent. As the non-aqueous electrolytic solution, an electrolytic solution in which a magnesium salt, a sodium salt, or a calcium salt is dissolved in an organic solvent can be used. The organic solvent is, for example, at least one selected from the group consisting of carbonate ester-based solvents such as dimethyl carbonate (DMC), methyl ethyl carbonate (MEC), methyl propyl carbonate (MPC), methyl isopropyl carbonate (MIPC), methyl butyl carbonate (MBC), diethyl carbonate (DEC), ethyl propyl carbonate (EPC), ethyl isopropyl carbonate (EIPC), ethyl butyl carbonate (EBC), dipropyl carbonate (DPC), diisopropyl carbonate (DIPC), dibutyl carbonate (DBC), ethylene carbonate (EC), propylene carbonate (PC), and 1,2-butylene carbonate (1,2-BC), ether-based solvents such as 1,2-dimethoxyethane (DME) and tetraethylene glycol dimethyl ether (TEGDME), lactone-based solvents such as γ-butyrolactone (GBL), and sulfoxide-based solvents such as dimethyl sulfoxide (DMSO). The magnesium salt, the sodium salt, and the calcium salt are respectively represented by Mg—X₂, Na—X, and Ca—X₂. Here, X may be, for example, Cl, Br, I, BF₄, PF₆, CF₃SO₃, ClO₄, CF₃CO₂, AsF₆, SbF₆, AlCl₄, N(CF₃SO₂)₂, N(CF₃CF₂SO₂)₂, PF₃(C₂F₅)₃, N(FSO₂)₂, N(FSO₂)(CF₃SO₂), N(CF₃CF₂SO₂)₂, N(C₂F₄S₂O₄), N(C₃F₆S₂O₄), N(CN)₂, N(CF₃SO₂)(CF₃CO), or R¹FBF₃ (where R¹F=n-CₘF₂ₘ₊₁, m=natural number of 1 to 4) and R²BF₃ (where R²=n-CₚH₂ₚ₊₁, p=natural number of 1 to 5). X is preferably Cl, Br, I, ClO₄, AlCl, or N(CN)₂ which is not a fluorine compound from the viewpoint of an environmental load. Furthermore, as X, a metal salt obtained by mixing two or more kinds among them can be used.

In the present embodiment, the case where the non-aqueous electrolytic solution is used for the electrolyte 102 is described, but a solid electrolyte such as an electrolyte in a gel form or an electrolyte in a solid form may be used. That is, the electrolyte 102 may be in any form such as a liquid form, a cream form, a gel form, or a solid form.

### (4) Other Elements

The secondary battery 100 of the present embodiment can include, in addition to the above constituent elements, a structural member such as a separator or a battery case, and other elements required for the secondary battery. As these elements, conventionally known ones can be used, but the elements preferably do not contain a harmful substance and a rare metal and the like from viewpoints of an environmental load and a disposal treatment. Furthermore, these other elements are more preferably bio-derived or biodegradable materials.

### (5) Method for Manufacturing Secondary Battery

As described above, the secondary battery 100 of the present embodiment contains at least the positive electrode 101, the negative electrode 103, and the electrolyte 102. As exemplified in FIG. 1, the electrolyte 102 is disposed between the positive electrode 101 and the negative electrode 103 so as to be in contact with the positive electrode 101 and the negative electrode 103. The secondary battery 100 having such a configuration can be prepared in a similar manner to a conventional secondary battery.

For example, in the secondary battery 100, elements of the positive electrode 101 containing the positive electrode active material containing cystine as described above, the negative electrode 103 containing magnesium (Mg), sodium (Na), or calcium (Ca), and the electrolyte 102 disposed so as to be in contact with the positive electrode 101 and the negative electrode 103 may be assembled according to a conventional technique. The positive electrode 101 may contain a conductive auxiliary agent and a binder.

As an embodiment of the method for manufacturing a secondary battery 100, for example, a coin-type secondary battery can be manufactured.

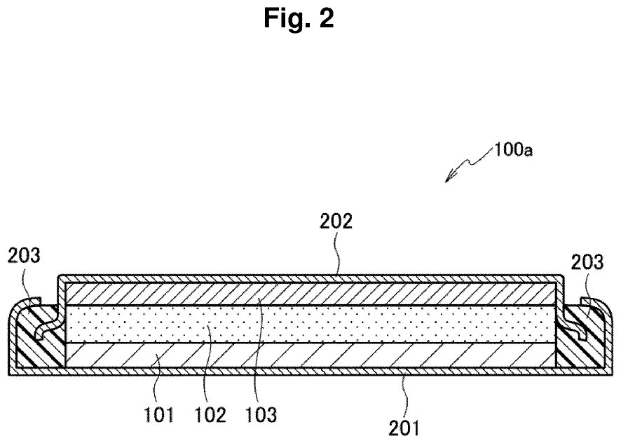

FIG. 2 is a schematic cross-sectional view showing the structure of a coin-type secondary battery 100a. Specifically, first, the positive electrode 101 is placed in a circular positive electrode case 201. A separator (not shown) is placed on the positive electrode 101, and a non-aqueous electrolytic solution is injected as the electrolyte 102 into the placed separator. A propylene gasket 203 is fitted into the outer peripheral edge of a circular negative electrode case 202. Next, the negative electrode 103 is placed on the electrolyte 102, and the positive electrode case 201 is covered with the negative electrode case 202 fitted with the propylene gasket 203. At this time, the positive electrode case 201 is covered with the negative electrode case 202 so that the propylene gasket 203 is brought into contact with the inner edge of the positive electrode case 201 and the positive electrode 101 and the negative electrode 103 are not brought into contact with each other. Next, the peripheral portion of the positive electrode case 201 and the negative electrode case 202 is crimped with a coin cell crimping machine, and thus the coin-type secondary battery 100a including the propylene gasket 203 can be produced.

The illustrated coin-type secondary battery 100a uses cystine as a positive electrode active material. Therefore, unlike an air battery using oxygen in the air as a positive electrode active material, the positive electrode case 201 of the present embodiment needs no air intake port. That is, in the present embodiment, a sealed battery can be produced. Therefore, the coin-type secondary battery 100a of the present embodiment can be stored for a long period of time without volatilizing the electrolytic solution from the air intake port.

### EXAMPLES

Hereinafter, Examples of a secondary battery 100 according to the present embodiment will be described in detail. In the secondary battery 100 used in each of Examples, each of magnesium (Mg), sodium (Na), and calcium (Ca) is used for a negative electrode 103. In the secondary battery 100 using each of magnesium (Mg), sodium (Na), and calcium (Ca) for the negative electrode 103, a propylene carbonate solution containing each of Mg(ClO₄)₂, NaClO₄, and Ca(ClO₄)₂ is used for an electrolyte 102. Note that the present invention is not limited to those described in the following Examples, and can be appropriately modified and implemented.

### First Example

In First Example, a coin-type secondary battery 100a shown in FIG. 2 was produced by the following procedure. Cystine was used as a positive electrode active material. As a negative electrode active material, each of a magnesium (Mg) foil, a sodium (Na) foil, and a calcium (Ca) foil was used. A propylene carbonate solution containing 0.5 mol/L of each of Mg(ClO₄)₂, NaClO₄, and Ca(ClO₄)₂ was used as an electrolyte 102 for the coin-type secondary battery 100a using each of a magnesium (Mg) foil, a sodium (Na) foil, and a calcium (Ca) foil.

### (Preparation of Positive Electrode 101)

A cystine powder (Tokyo Chemical Industry Co., Ltd.), a Ketjen black powder (EC600JD, Lion Specialty Chemicals Co., Ltd.), and a polytetrafluoroethylene (PTFE) powder were sufficiently pulverized and mixed at the weight ratio of 80:10:10 using a pounding machine, and roll-formed to produce a sheet-like electrode (thickness: 0.5 mm). The sheet-like electrode was cut into a circle having a diameter of 16 mm and pressed on a copper mesh to obtain a positive electrode 101.

### (Preparation of Negative Electrode 103)

Each of a magnesium (Mg) foil (thickness: 150 μm, Nilaco Corporation), a sodium (Na) foil (thickness: 150 μm, Sigma-Aldrich Co. LLC) and a calcium (Ca) foil (thickness: 150 μm, Nilaco Corporation) was cut out into a circle having a diameter of 16 mm, and each of these was bonded to a copper foil (Nilaco Corporation) using an ultrasonic welding machine to obtain a negative electrode 103.

### (Preparation of Secondary Battery 100)

The coin-type secondary battery 100a shown in FIG. 2 was produced using a coin battery case (Hohsen Corp.).

A cellulose-based separator (Nippon Kodoshi Corporation) cut into a circle having a diameter of 18 mm is placed on a positive electrode case 201 in which the positive electrode 101 prepared by the above-described method is placed, and a propylene carbonate solution (Kishida Chemical Co., Ltd.) containing each of Mg(ClO₄)₂, NaClO₄, and Ca(ClO₄)₂ is injected into the placed separator as the electrolyte 102. The negative electrode 103 was placed on the electrolyte 102, the positive electrode case 201 was covered with the negative electrode case 202, a peripheral portion of the positive electrode case 201 and the negative electrode case 202 was crimped with a coin cell crimping machine, and thus the coin-type secondary battery 100a including a propylene gasket 203 was obtained.

### (Battery Performance)

The battery performance of the secondary battery 100 prepared by the above-described procedure was measured. In the cycle test of the battery, a current was caused to flow at a current density per effective area of the positive electrode 101 of 1.0 mA/cm² using a charge/discharge measurement system (manufactured by Bio Logic), and a discharge voltage was measured until a battery voltage decreased from an open circuit voltage to 0.10 V. The discharge test of the battery was performed under a normal living environment. The discharge capacity is represented by a value (mAh/g) per unit weight of the positive electrode active material (cystine).

Table 1 shows the discharge capacities and the discharge voltages of the secondary battery of First Example. As shown in Table 1, the discharge voltages of First Example in the battery using magnesium (Mg), sodium (Na), and calcium (Ca) for the negative electrode 103 were respectively 0.5 V, 1.0 V, and 1.1 V, and the discharge capacities were respectively 82 mAh/g, 142 mAh/g, and 101 mAh/g. Here, the discharge voltage is defined as a discharge voltage at a discharge capacity of ½ of the total discharge capacity. As described above, it has been found that the secondary batteries of First Example have excellent battery performance.

TABLE 1

| | Negative | | | |
|---|---|---|---|---|
| | electrode | | | |
| Examples | active material | Mg | Na | Ca |
| First | Discharge | 0.5 | 1.0 | 1.1 |
| example | voltage (V) | | | |
| | Discharge | 82 | 142 | 101 |
| | capacity | | | |
| | (mAh/g) | | | |
| Second | Discharge | 1.1 | 1.5 | 1.7 |
| example | voltage (V) | | | |
| | Discharge | 124 | 172 | 154 |
| | capacity | | | |
| | (mAh/g) | | | |
| Third | Discharge | 1.4 | 1.8 | 2.0 |
| example | voltage (V) | | | |
| | Discharge | 162 | 226 | 215 |
| | capacity | | | |
| | (mAh/g) | | | |
| Fourth | Discharge | 1.8 | 2.0 | 2.2 |
| example | voltage (V) | | | |
| | Discharge | 212 | 288 | 278 |
| | capacity | | | |
| | (mAh/g) | | | |

### Second Example

In Second Example, a coin-type secondary battery 100a shown in FIG. 2 was produced by the following procedure. Preparation was performed by using Cystine as a positive electrode active material and supporting the positive electrode active material on a nonwoven fabric-shaped current collector (carbon felt) containing carbon. As a negative electrode active material, each of a magnesium (Mg) foil, a sodium (Na) foil, and a calcium (Ca) foil was used. A propylene carbonate solution containing 0.5 mol/L of each of Mg(ClO₄)₂, NaClO₄, and Ca(ClO₄)₂ was used as an electrolyte 102 for the coin-type secondary battery 100a using each of a magnesium (Mg) foil, a sodium (Na) foil, and a calcium (Ca) foil.

The evaluation method of the battery is the same as that of First Example.

### (Preparation of Positive Electrode 101)

A carbon felt (Toyobo Co., Ltd.) was immersed in a liquid obtained by dissolving a cystine powder (Tokyo Chemical Industry Co., Ltd.) in 1.0 M hydrochloric acid (Tokyo Chemical Industry Co., Ltd.). The carbon felt was dried in a vacuum dryer at 80° C. for 30 minutes to precipitate cystine on the carbon felt, and then washed with pure water. The cystine containing carbon felt was cut into a circle having a diameter of 16 mm to obtain a positive electrode 101.

### (Preparation of Negative Electrode 103)

Each of a magnesium (Mg) foil (thickness: 150 μm, Nilaco Corporation), a sodium (Na) foil (thickness: 150 μm, Sigma-Aldrich Co. LLC), and a calcium (Ca) foil (thickness: 150 μm, Nilaco Corporation) was cut out into a circle having a diameter of 16 mm, and each of these was bonded to a copper foil (Nilaco Corporation) using an ultrasonic welding machine to obtain a negative electrode 103.

### (Preparation of Secondary Battery 100)

The coin-type secondary battery 100a shown in FIG. 2 was produced using a coin battery case (Hohsen Corp.).

A cellulose-based separator (Nippon Kodoshi Corporation) cut into a circle having a diameter of 18 mm is placed on a positive electrode case 201 in which the positive electrode 101 prepared by the above-described method is placed, and a propylene carbonate solution (Kishida Chemical Co., Ltd.) containing each of Mg(ClO₄)₂, NaClo₄, and Ca(ClO₄)₂ is injected into the placed separator as the electrolyte 102. The negative electrode 103 was placed on the electrolyte 102, the positive electrode case 201 was covered with the negative electrode case 202, a peripheral portion of the positive electrode case 201 and the negative electrode case 202 was crimped with a coin cell crimping machine, and thus the coin-type secondary battery 100a including a propylene gasket 203 was obtained.

### (Battery Performance)

Table 1 shows the discharge capacities and the discharge voltages of the secondary batteries of Second Example. As shown in Table 1, the discharge capacity of the battery using magnesium (Mg) for the negative electrode 103 of Second Example was 124 mAh/g, which was greater than that of First Example. Also in the battery using each of sodium (Na) and calcium (Ca) for the negative electrode, the discharge capacity was larger than that of First Example.

As shown in Table 1, the discharge voltage of Second Example is larger than the discharge voltage of First Example. That is, a decrease in overvoltage was observed in Second Example than in First Example, and improvement in discharge energy efficiency was achieved.

These characteristics are considered to be improved because the positive electrode 101 formed by bonding the positive electrode active material to the carbon felt is used, and therefore the internal resistance of the battery is reduced and the battery reaction is efficiently performed.

### Third Example

In Third Example, a coin-type secondary battery 100a shown in FIG. 2 was produced by the following procedure. Preparation was performed by using Cystine as a positive electrode active material and supporting the positive electrode active material on a co-continuous body. As a negative electrode active material, each of a magnesium (Mg) foil, a sodium (Na) foil, and a calcium (Ca) foil was used. A propylene carbonate solution containing 0.5 mol/L of each of Mg(ClO₄)₂, NaClO₄, and Ca(ClO₄)₂ was used as an electrolyte 102 for the coin-type secondary battery 100a using each of a magnesium (Mg) foil, a sodium (Na) foil, and a calcium (Ca) foil.

The evaluation method of the battery is the same as those of First Example and Second Example.

### (Preparation of Positive Electrode 101)

The co-continuous body was immersed in a liquid obtained by dissolving a cystine powder (Tokyo Chemical Industry Co., Ltd.) in 1.0 M hydrochloric acid (Tokyo Chemical Industry Co., Ltd.). The co-continuous body was dried in a vacuum dryer at 80° C. for 30 minutes to precipitate cystine on the co-continuous body, and then washed with pure water. The cystine-containing co-continuous body was cut into a circle having a diameter of 16 mm to obtain a positive electrode 101.

In the manufacture of the co-continuous body, first, a bacterial cellulose gel produced from Acetobacter xylinum as an acetic acid bacterium was placed in a test tube, and the test tube was immersed in liquid nitrogen for 30 minutes to completely freeze the bacterial cellulose gel. Next, the frozen bacterial cellulose gel was taken out into an eggplant flask and dried in a vacuum of 10 Pa or less by a freeze dryer (TOKYO RIKAKIKAI CO., LTD.). Thereafter, the dried product was carbonized by firing at 1200° C. for 2 hours under a nitrogen atmosphere to manufacture the co-continuous body.

### (Preparation of Negative Electrode 103)

Each of a magnesium (Mg) foil (thickness: 150 μm, Nilaco Corporation), a sodium (Na) foil (thickness: 150 μm, Sigma-Aldrich Co. LLC) and a calcium (Ca) foil (thickness: 150 μm, Nilaco Corporation) was cut out into a circle having a diameter of 16 mm, and each of these was bonded to a copper foil (Nilaco Corporation) using an ultrasonic welding machine to obtain a negative electrode 103.

### (Preparation of Secondary Battery 100)

The coin-type secondary battery 100a shown in FIG. 2 was produced using a coin battery case (Hohsen Corp.).

A cellulose-based separator (Nippon Kodoshi Corporation) cut into a circle having a diameter of 18 mm is placed on a positive electrode case 201 in which the positive electrode 101 prepared by the above-described method is placed, and a propylene carbonate solution (Kishida Chemical Co., Ltd.) containing each of Mg(ClO₄)₂, NaClO₄, and Ca(ClO₄)₂ is injected as the electrolyte 102 into the placed separator. The negative electrode 103 was placed on the electrolyte 102, the positive electrode case 201 was covered with the negative electrode case 202, a peripheral portion of the positive electrode case 201 and the negative electrode case 202 was crimped with a coin cell crimping machine, and thus the coin-type secondary battery 100a including a propylene gasket 203 was obtained.

### (Battery Performance)

Table 1 shows the discharge capacities and the discharge voltages of the secondary batteries of Example 3. As shown in Table 1, the discharge capacity of the battery using magnesium (Mg) for the negative electrode 103 of Example 3 was 162 mAh/g, which was greater than those of Example 1 and Example 2. Also in the battery using each of sodium (Na) and calcium (Ca) for the negative electrode 103, the discharge capacity was larger than those of First and Second Examples.

As shown in Table 1, the discharge voltage of Third Example is larger than those of First and Second Examples. That is, a decrease in overvoltage was observed in Third Example than in First and Second Examples, and improvement in discharge energy efficiency was achieved.

The improvement in these characteristics is considered to be due to the increase in the supported amount of the positive electrode active material because the positive electrode 101 formed by joining the positive electrode active material to the co-continuous body was used.

### Fourth Example

In Fourth Example, a coin-type secondary battery 100a shown in FIG. 2 was produced by the following procedure. Preparation was performed by using a compound obtained by polymerizing cystine as a positive electrode active material and supporting the positive electrode active material on a co-continuous body. As a negative electrode active material, each of a magnesium (Mg) foil, a sodium (Na) foil, and a calcium (Ca) foil was used. A propylene carbonate solution containing 0.5 mol/L of each of Mg(ClO₄)₂, NaClO₄, and Ca(ClO₄)₂ was used as an electrolyte 102 for the coin-type secondary battery 100a using each of a magnesium (Mg) foil, a sodium (Na) foil, and a calcium (Ca) foil.

The evaluation method of the battery is the same as those of First, Second, and Third Examples. Note that measurement in a charge/discharge test was performed until a discharge voltage decreased to 0.10 V.

### (Preparation of Positive Electrode 101)

The co-continuous body was immersed in a liquid obtained by dissolving a compound obtained by polymerizing cystine in tetrahydrofuran (THF) (Tokyo Chemical Industry Co., Ltd.). The co-continuous body was dried in a vacuum dryer at 80° C. for 30 minutes to precipitate a compound obtained by polymerizing cystine on the co-continuous body. Thereafter, the compound-containing co-continuous body obtained by polymerizing cystine was cut into a circle having a diameter of 16 mm to obtain a positive electrode 101.

In the manufacture of the compound obtained by polymerizing cystine, first, ethyl acetate (Tokyo Chemical Industry Co., Ltd.), (1S)-(−)-α-pinene (Tokyo Chemical Industry Co., Ltd.), and bis(trichloromethyl) carbonate (Tokyo Chemical Industry Co., Ltd.) were added to a cystine powder (Tokyo Chemical Industry Co., Ltd.) under an Ar atmosphere. The mixture was stirred at 90° C. for 3 hours, and an insoluble matter in the solution was then separated by filtration. Hexane was added to the solution. The mixture was stirred for 30 minutes, and the precipitated solid was then collected by suction filtration. Ethyl acetate and hexane were again added to the obtained residue. Then, the mixture was stirred for 50 minutes, and the precipitated solid was collected by suction filtration and dried under reduced pressure for 12 hours to obtain N-carboxy anhydride (NCA) of cystine. Next, under an Ar atmosphere, dichloromethane (Tokyo Chemical Industry Co., Ltd.), butylamine (Tokyo Chemical Industry Co., Ltd.), and dichloromethane (Tokyo Chemical Industry Co., Ltd.) were added to the N-carboxy anhydride of cystine, and the mixture was stirred at 30° C. for 12 hours. Thereafter, diethyl ether (Tokyo Chemical Industry Co., Ltd.) was added, and the precipitated solid was recovered by suction filtration and dried under reduced pressure for 12 hours to manufacture a compound in which cystine was polymerized.

In the manufacture of the co-continuous body, first, a bacterial cellulose gel produced from Acetobacter xylinum as an acetic acid bacterium was placed in a test tube, and the test tube was immersed in liquid nitrogen for 30 minutes to completely freeze the bacterial cellulose gel. Next, the frozen bacterial cellulose gel was taken out into an eggplant flask and dried in a vacuum of 10 Pa or less by a freeze dryer (TOKYO RIKAKIKAI CO., LTD.). Thereafter, the dried product was carbonized by firing at 1200° C. for 2 hours under a nitrogen atmosphere to manufacture the co-continuous body.

### (Preparation of Negative Electrode 103)

Each of a magnesium (Mg) foil (thickness: 150 μm, Nilaco Corporation), a sodium (Na) foil (thickness: 150 μm, Sigma-Aldrich Co. LLC) and a calcium (Ca) foil (thickness: 150 μm, Nilaco Corporation) was cut out into a circle having a diameter of 16 mm, and each of these was bonded to a copper foil (Nilaco Corporation) using an ultrasonic welding machine to obtain a negative electrode 103.

### (Preparation of Secondary Battery 100)

The coin-type secondary battery 100a shown in FIG. 2 was produced using a coin battery case (Hohsen Corp.).

A cellulose-based separator (Nippon Kodoshi Corporation) cut into a circle having a diameter of 18 mm is placed on a positive electrode case 201 in which the positive electrode 101 prepared by the above-described method is placed, and a propylene carbonate solution (Kishida Chemical Co., Ltd.) containing each of Mg(ClO₄)₂, NaClO₄, and Ca(ClO₄)₂ is injected as the electrolyte 102 into the placed separator. The negative electrode 103 was placed on the electrolyte 102, the positive electrode case 201 was covered with the negative electrode case 202, a peripheral portion of the positive electrode case 201 and the negative electrode case 202 was crimped with a coin cell crimping machine, and thus the coin-type secondary battery 100a including a propylene gasket 203 was obtained.

### (Battery Performance)

Table 1 shows the discharge capacities and the discharge voltages of the secondary batteries of Fourth Example. As shown in Table 1, the discharge capacity of the battery using magnesium (Mg) for the negative electrode of Fourth Example was 212 mAh/g, which was greater than those of First, Second, and Third Examples. Also in the battery using each of sodium (Na) and calcium (Ca) for the negative electrode, the discharge capacity was larger than those of First, Second, and Third Examples.

As shown in Table 1, the discharge voltage of Fourth Example is larger than those of First, Second, and Third Examples. That is, a decrease in overvoltage was observed in Fourth Example than in First, Second, and Third Examples, and improvement in discharge energy efficiency was achieved.

Furthermore, as shown in Table 2, the discharge capacity after 20 cycles of Example 4 was 162 mAh/g, which was larger than those of First, Second, and Third Examples.

TABLE 2

| | Negative | | | |
|---|---|---|---|---|
| | electrode | | | |
| Examples | active material | Mg | Na | Ca |
| First | Discharge | 4 | 6 | 5 |
| example | capacity after | | | |
| | 20 cycles | | | |
| | (mAh/g) | | | |
| Second | Discharge | 12 | 16 | 14 |
| example | capacity after | | | |
| | 20 cycles | | | |
| | (mAh/g) | | | |
| Third | Discharge | 18 | 24 | 20 |
| example | capacity after | | | |
| | 20 cycles | | | |
| | (mAh/g) | | | |
| Fourth | Discharge | 162 | 220 | 216 |
| example | capacity after | | | |
| | 20 cycles | | | |
| | (mAh/g) | | | |

These characteristics are considered to be improved because the positive electrode 101 formed by bonding a polymerized positive electrode active material to the co-continuous body is used to increase the supported amount of the positive electrode active material, and furthermore, the positive electrode active material is hardly dissolved in the electrolyte 102 by an electrochemical reaction.

In addition, the secondary battery 100 of the present embodiment is a sealed battery that needs no air intake port unlike an air battery. Therefore, the secondary battery 100 of the present embodiment can be stored for a long period of time without volatilization of the electrolytic solution from an air intake port.

Therefore, the secondary battery 100 of the present embodiment can be effectively used as a new drive source for various electronic devices such as small devices, sensors, and mobile devices.

The present invention is not limited to the above embodiments, and various modifications can be made within the scope of the concept of the present invention.

### REFERENCE SIGNS LIST

100 Secondary battery
101 Positive electrode
102 Electrolyte
103 Negative electrode
201 Positive electrode case
202 Negative electrode case
203 Propylene gasket

1. A secondary battery comprising:
a positive electrode containing cystine;
a negative electrode containing magnesium, sodium, or calcium; and
an electrolyte disposed between the positive electrode and the negative electrode.

2. The secondary battery according to claim 1, wherein
the positive electrode contains a polymer containing a repeating unit represented by Formula (1).

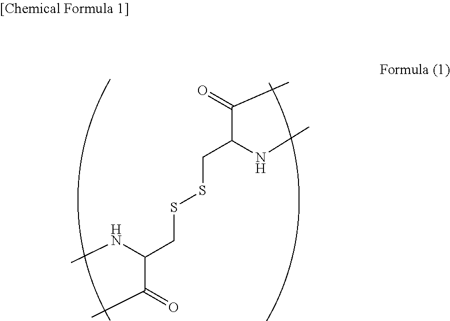

3. The secondary battery according to claim 1, wherein
the positive electrode is formed into a porous body containing at least one selected from the group consisting of aluminum, copper, and iron, or a nonwoven fabric-shaped current collector containing carbon, and
does not contain a binder.

4. The secondary battery according to claim 1, wherein
the positive electrode is formed into a co-continuous body having a three-dimensional network structure provided by branching of a plurality of integrated nanostructures, and
does not contain a binder.
